(19) United States
(12) Patent Application Publication
(10) Pub. No.: US 2005/0116395 A1
(43) Pub. Date: Jun. 2, 2005

(54) Method for aluminum residue ash recycling utilization

(76) Inventor: Shun-Yuan Tsai, Tainan City (TW)

Correspondence Address: Spire Environmental Protection Technologies., Ltd., P.O. Box No. 6-57, Junghe, Taipei, 235, TW

(21) Appl. No.: 10/724,702

(22) Filed: Dec. 2, 2003

(51) Int. Cl. C04B 33/32

(52) U.S. Cl. 264/655; 264/660; 264/661

(57) ABSTRACT

A method for aluminum residue ash recycling utilization, primarily implementing calcination of residual aluminum residue ash waste material left over after separating and recycling aluminum metal from refined aluminum slag, and therefrom manufacturing a raw material for fire-proof materials, thereby achieving objective of recycling aluminum residue ash. Furthermore, through grinding the aforesaid raw material, adding admixtures and sintering, manufacture of a ceramic filter medium with a high unit price is attained.

### BACKGROUND OF THE INVENTION

(a) Field of the Invention

The present invention relates to a method for aluminum residue ash recycling utilization, primarily implementing calcination of residual aluminum residue ash waste material left over after separating and recycling aluminum metal from refined aluminum slag, and therefrom manufacturing a raw material for fire-proof materials, thereby achieving objective of recycling aluminum residue ash. Furthermore, the present invention accomplishes a manufacturing method for producing ceramic filter medium by further complementing the aforementioned fireproof raw material with other raw materials.

(b) Description of the Prior Art

Aluminum is the most abundant metallic element deposited in the earth's crust, is very reactive, and does not exist in a metallic state in nature. Application of aluminum metal gradually emerged only after appearance of aluminum metal refining techniques in the 19th century. Up to present, aluminum is second only to ferrous metals in application usage, and applications for aluminum usage continue to grow.

Aluminum is a highly reactive metal; therefore during process of refining aluminum in an aluminum regeneration plant, oxidized dross is easily produced. After removing and cooling of this dross, so called refined aluminum slag (abbreviated to aluminum slag) is attained. During the process of abstracting aluminum slag from refined aluminum, a fraction of aluminum metal is mingled with the aluminum slag. Thus, a general procedure for treating aluminum slag is to separate and recycle the aluminum metal residual in the aluminum slag. Surplus material leftover after separating out the aluminum metal is then discarded. This discarded material is called aluminum residue ash. Chemical composition of the aluminum residue ash primarily consists of aluminum oxide, silicon oxide, sodium oxide, ferric oxide, magnesium oxide and calcium oxide. Proportion of each component varies according to raw materials used and working conditions of each aluminum regeneration plant, however, typical aluminum residue ash components are: 70%-80% aluminum oxide (Al₂O₃), 9%-12% silicon dioxide (SiO₂), 3%-6% sodium oxide (Na₂O), 2%-4% ferric oxide (Fe₂O₃), 2%-4% magnesium oxide (MgO), 1%-2% calcium oxide (CaO). Grain size of the aluminum residue ash also varies according to sifting operating conditions of each aluminum regeneration plant, but is normally below 20 meshes.

Regarding a ceramic filter medium, the ceramic filter medium is corrosion-tolerant, heat resistant, has large mechanical strength, high porosity, good liquid flow, products with non-dissolved out substances will not cause liquids to suffer secondary pollution, and is easy to clean. Such advantages have made the ceramic filter medium be extensively used for filtrate purposes by various lines of businesses for water treatment, purification of intoxicating liquors, edible oils . . . etc, whereby the ceramic filter medium can replace cotton textiles, plastics, metal meshing and irregular granular filling material (sand, gravel, scoria) etc. The ceramic filter medium is thus an extremely popular product in international markets.

However, presently, manufacture of ceramic filter medium relies on all new aluminum raw materials, and cannot utilize disused resources to implement regeneration.

Inventor of the present invention has carried out extensive research in field of aluminum residue ash recycling utilization over many years, and accumulated abundant practical experience. In the year 2000, the inventor of the present invention utilized phosphoric acid or sulphuric acid for implementing a stabilization treatment of aluminum residue ash, therefrom, with addition of sand and cement, pressure is applied to carry out a method of producing cement blocks, and providing a valid solution for utilization of aluminum residue ash recycling. The aforementioned method also acquired the Republic of China invention patent No. 143711. The inventor of the present invention, after a further period of research over many years perfected the present invention as disclosed hereinafter.

### SUMMARY OF THE INVENTION

The present invention is characterized in being based on aluminum residue ash having high aluminum content, and having a chemical composition comparable to raw material of fire-proof materials, and thereby utilizes this characteristic to produce a raw material for fire-proof materials. Basic steps of the present invention are as follows:
a. Take aluminum residue ash as the raw material;
b. Implement high temperature calcination and stabilization;
c. Manufacture the raw material for the fireproof materials.

Utilizing the aforementioned steps not only fully enables recycling of aluminum residue ash, but also resolves problem of treating aluminum residue ash, as well as enhancing added value of the aluminum residue ash and effectively reducing squander of energies and resources in manufacturing the raw material for fire-proof materials.

The raw material of the fireproof materials as manufactured in aforesaid steps is a α aluminum oxide (α—Al₂O₃). After sintering the α aluminum oxide complemented with other raw materials, a ceramic filter medium is produced thereof. Follow-up steps being:
d. Grinding the α aluminum oxide (a—Al₂O₃);
e. Adding admixture, such as a binding admixture, a porous forming agent, a fluxing agent, a stabilizing agent . . . etc.;
f. Mixing and refine;
g. Molding the ceramic filter medium into an embryo shape;
h. Drying the ceramic filter medium embryo shape;
i. Sintering;
j. Lowering temperature;
k. Completing finished product.

Implementing aforementioned follow-up steps thereby enhances added value of the aluminum residue ash, and facilitates manufacture of the ceramic furnace material (or fire-proof materials), completely eliminating reliance on the all-new raw materials, thus averting the squandering of resources and energy.

With the present invention, what was originally looked upon and deemed to be waste material, aluminum residue ash can now effectively undergo recycling, and therefrom produce ceramic filter medium of high unit price.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a flow chart of basic steps according to the present invention.

FIG. 2 shows a chart depicting results of X-ray diffraction analysis of aluminum residue ash after calcination at 1300° C. according to the present invention.

FIG. 3 shows a layered chart depicting results of X-ray diffraction analysis of aluminum residue ash after calcination at temperatures between 800° C. and 1500° C. according to the present invention.

FIG. 4 shows a flow chart of basic steps in manufacturing process of ceramic filter medium according to the present invention.

FIG. 5 shows a proportion chart of each chemical compound making up raw materials in the manufacturing process of ceramic filter medium according to the present invention

### DETAILED DESCRIPTION OF THE PREFERRED EMBODIMENTS

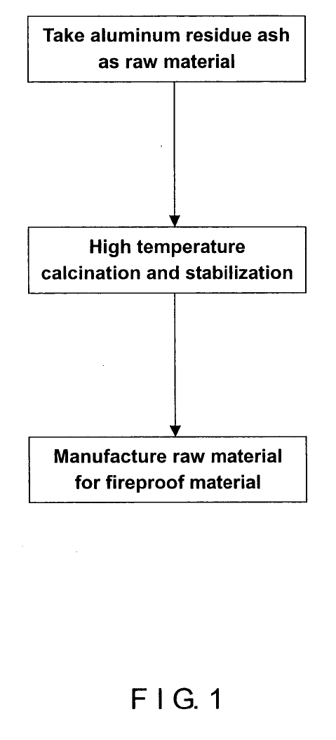

Referring to FIG. 1, which shows basic steps of the present invention as disclosed hereinafter:
a. Take aluminum residue ash as the raw material;
b. Implement high temperature calcination and stabilization;
c. Manufacture the raw material for the fireproof materials.

The aforementioned steps essentially utilize a high temperature kiln to implement calcination of the aluminum residue ash, thereby converting the aluminum residue ash into a primary component material —aluminum oxide (mineral crystal phase is corundum), and therefrom are used as the raw material for manufacture of fireproof materials. During calcination, aluminum nitride (AlN) and aluminum carbide (Al₄C₃) influence recycling process and act to stabilize such.

Temperature range of the aforesaid high temperature calcination is from 800° C. to 1800° C.

Furthermore, the aforesaid aluminum residue ash refers to residual left over after separating and recycling aluminum metal from refined aluminum slag, or material from the slag of aluminum refining after undergoing a crushing and grinding process to produce fine granules.

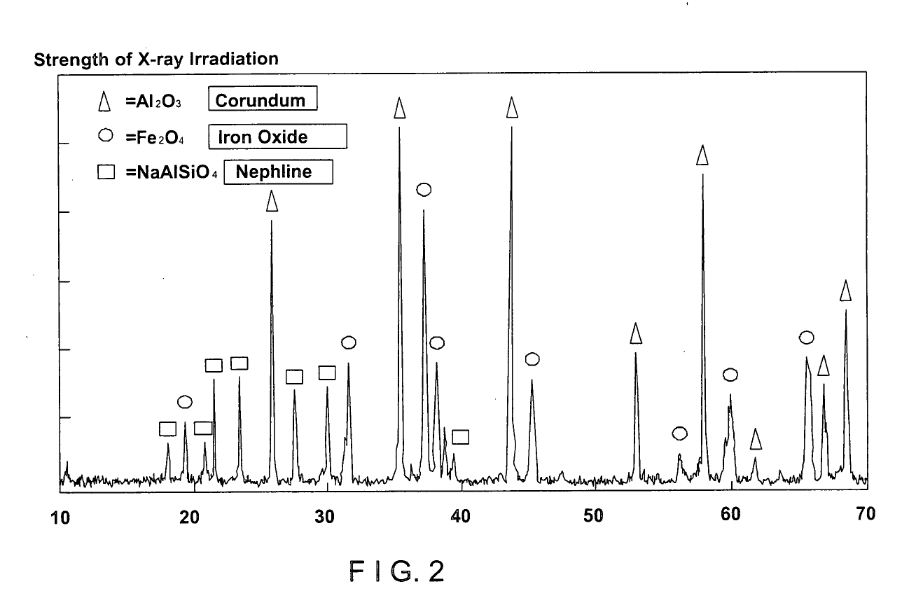

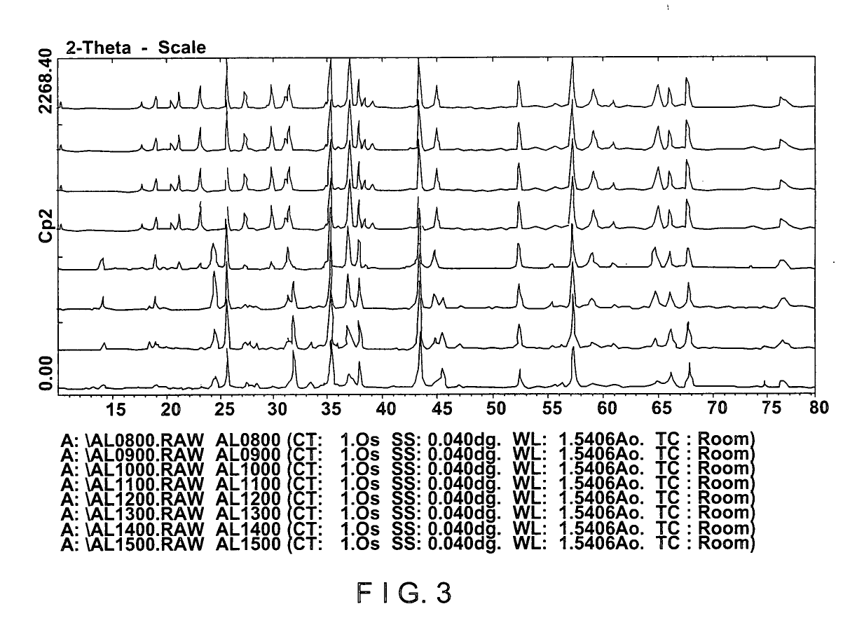

On the basis of aforesaid method, whereby the aluminum residue ash material obtained after calcination at 800° C., from results of X-ray diffraction analysis (XRD), there is clear evidence of corundum crystal phase production (see FIG. 2, which depicts results of X-ray diffraction analysis of aluminum residue ash after calcination at 1300° C., wherein X axis and Y axis represent angle of X-ray irradiation and strength of X-Ray irradiation respectively). The aforementioned corundum crystal phase is more evident the higher the temperature calcination is carried out at (FIG. 3 depicts a layered chart of results of X-ray diffraction analysis of aluminum residue ash after calcination at temperatures between 800° C. and 1500° C.). Therefore, by controlling the temperature during calcination of the aluminum residue ash, the raw material so produced can be assorted into different grades according to application requirements of the fireproof materials. The fireproof materials so produced include set-setting and non set-setting fireproof materials of refractory bricks, refractory mortar and teeming materials, and the raw materials of the fire-proof materials so produced refer to admixtures added during manufacturing process of the fire-proof materials.

During the process of calcination, aluminum nitride (AlN) and aluminum carbide (Al₄C₃) influence the recycling process and act to stabilize such, having reaction equations as follows:
4AlN+7O₂→2Al₂O₃+4NO₂
Al₄C₃₊₆O₂→2Al₂O₃+3CO₂

The aforementioned method thereby facilitates effectively resolving the problem of the aluminum residue ash waste treatment, and provides the aluminum residue ash with a high economic value, as well as economizing on energy required to produce the fire-proof materials and averting the squandering of resources.

The aforementioned steps provide the aluminum residue ash with beneficial value to recycling, and are essential steps of an embodiment according to the present invention. The aluminum residue ash produced after calcination is an a aluminum oxide (α—Al₂O₃), having an appearance of a light straw-color powder form, with primary components including silicon dioxide (SiO₂), aluminum oxide (Al₂O₃), ferric oxide (Fe₂O₃), calcium oxide (CaO) and other trace elements.

If the aforementioned basic steps are employed in conjunction with other steps, then other recycling benefits are realized. An embodiment whereby follow-up steps are implemented after the basic steps, as disclosed above, and therefrom manufacturing a ceramic filter medium, are detailed hereinafter.

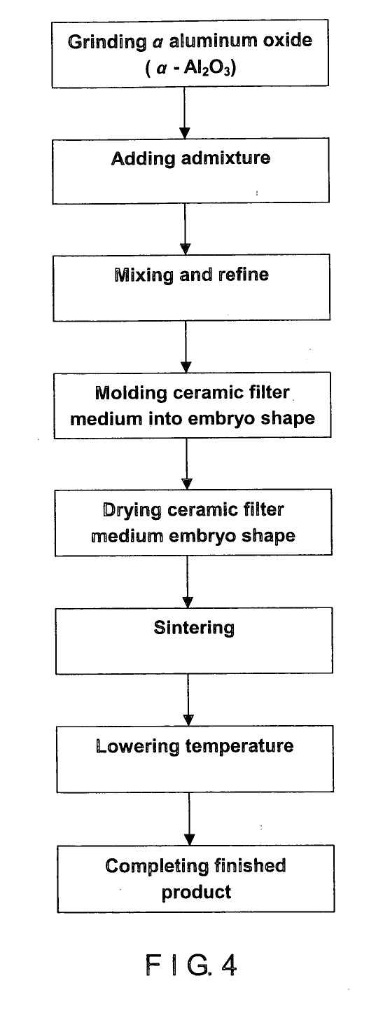

Referring to FIG. 4, which depicts aforesaid follow-up steps are detailed hereinafter:

d. Grind the α aluminum oxide (α—Al₂O₃)

The α aluminum oxide is ground to a grain size between 250 meshes and 800 meshes, whereby the grain size is determined by aperture of finished product of the ceramic filter medium. Using the α aluminum oxide as the main material can guarantee properties of strength and heat-resistance of the ceramic filter medium.
e. Add admixture, such as a binding agent, a porous forming agent, a fluxing agent, a stabilizing agent . . . etc.;

Wherein the binding agent is black clay, also called autumn soil, or king wood, having components including silicon dioxide (SiO₂), aluminum oxide (Al₂O₃), ferric oxide (Fe₂O₃), titanium dioxide (TiO₂), calcium oxide (CaO), magnesium oxide (MgO), potassium oxide (K₂O), sodium oxide (Na₂O) and other trace elements, and therewith admixed material can attain a molding property, which facilitates half-finished products to possess a specific mechanical strength, and ease of transport and sintering. The porous forming agent is charcoal dust, having components including carbon and other trace elements, and therewith can facilitate uniform distribution of pores within the ceramic filter medium and to having large micro-absorbability. The fluxing agent is feldspar, having components including silicon dioxide (SiO₂), aluminum oxide (Al₂O₃), ferric oxide (Fe₂O₃), titanium dioxide (TiO₂), calcium oxide (CaO), magnesium oxide (MgO), potassium oxide (K₂O), sodium oxide (Na₂O) and other trace elements, and therewith facilitates lowering sintering temperature and enabling the finished product to possess adequate strength to prevent substances from dissolving out from the finished product. The stabilizing agent is zirconium silicate, having components including silicon dioxide (SiO₂), zirconium oxide (ZrO₂), and therewith increases chemistry stability of the ceramic filter medium products. In addition to the above admixtures, sintered steatite is further used as an additive agent, having components including silicon dioxide (SiO₂), aluminum oxide (Al₂O₃), ferric oxide (Fe₂O₃), titanium dioxide (TiO₂), calcium oxide (CaO), magnesium oxide (MgO), potassium oxide (K₂O), sodium oxide (Na2O) . . . etc.
f. Mix and refine;

The ground α aluminum oxide is mixed and refined with the admixtures.
g. Mold the ceramic filter medium into an embryo shape;

The ceramic filter medium is molded into the embryo shape according to shape requirements, such as tubular shape, column shape, panel shaped, granular shaped . . . etc. Moisture content of the raw material is ≦2%. Molding moisture (5% dextrin C₆H₁₀O₅ aqueous solution) is 12˜15% (discrepancy exists due to different manufacturing processes).
h. Dry the ceramic filter medium embryo shape;

Drying temperature is between 300-350° C., and after drying, moisture content of the half-finished product is 1-2%.
i. Sintering

Sintering temperature is between 1240-1280° C., sintering time is 8 hours, with a heat preservation period of 2 hours.
j. Lower temperature

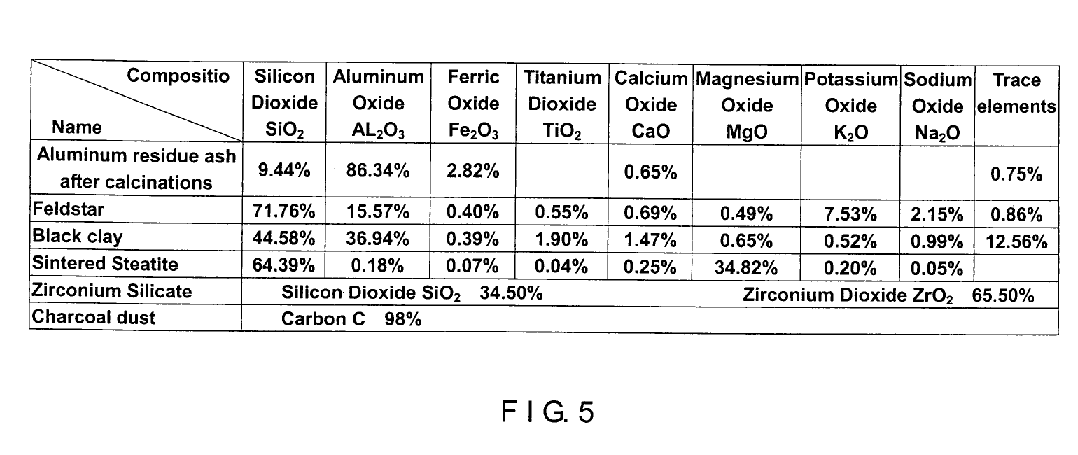

After sintering, the temperature of the half-finished product is lowered to normal temperature.
k. Complete finished product. Referring to aforementioned steps e and f, proportion of each chemical compound making up each raw material is as depicted in FIG. 5, however discrepancies will exist in these proportions depending on differences in source of raw materials.

In addition, again referring to aforementioned steps e and f, when mixing each raw material preferred proportions are: 74.8% aluminum residue ash, 9.4% black clay, 4.7% charcoal dust, 5.6% feldspar, 1.8% zirconium silicate, and 3.7% sintered steatite.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A method for aluminum residue ash recycling utilization, comprising steps of:
a. taking aluminum residue ash as raw material;
b. implementing high temperature calcination and stabilization;
c. manufacturing the raw material for fireproof materials.

2. The method for aluminum residue ash recycling utilization as claimed in claim 1, wherein the temperature for calcination ranges from 800° C. to 1800° C.

3. The method for aluminum residue ash recycling utilization as claimed in claim 1, wherein aluminum nitride (AlN) and aluminum carbide (Al₄C₃) are utilized to influence stabilization of the high temperature calcination method.

4. The method for aluminum residue ash recycling utilization as claimed in claim 1, wherein a aluminum oxide (α—Al₂O₃) is the raw material of the fire-proof materials.

5. The method for aluminum residue ash recycling utilization as claimed in claim 1, further comprising steps of:
d. grinding the α aluminum oxide (α—Al₂O₃);
e. adding admixture, such as a binding agent, a porous forming agent, a fluxing agent, a stabilizing agent . . . etc.;
f. mixing and refine;
g. molding the ceramic filter medium into an embryo shape;
h. drying the ceramic filter medium embryo shape;
i. sintering;
j. Lowering temperature;
k. Completing finished product.

6. The method for aluminum residue ash recycling utilization as claimed in claim 5, wherein the binding agent of the admixture is black clay, the porous forming agent is charcoal dust, the fluxing agent is feldspar, the stabilizing agent is zirconium silicate, with preferred proportions of each raw material being: 74.8% aluminum residue ash, 9.4% black clay, 4.7% charcoal dust, 5.6% feldspar, 1.8% zirconium silicate, and 3.7% sintered steatite.

7. The method for aluminum residue ash recycling utilization as claimed in claim 5, wherein the α aluminum oxide is ground to a grain size between 250 mesh and 800 mesh.
